(19) United States
(12) Patent Application Publication
(10) Pub. No.: US 2019/0335293 A1
(43) Pub. Date: Oct. 31, 2019

(54) Use of a mobile connectivity emulator device to assist with locating persons via transport vehicle

(71) Applicants: Cameron Ellis, League City, TX (US); Robert Cousins, Saratoga, CA (US)

(72) Inventors: Cameron Ellis, League City, TX (US); Robert Cousins, Saratoga, CA (US)

(21) Appl. No.: 15/962,679

(22) Filed: Apr. 25, 2018

(51) Int. Cl. H04W 4/02; H04W 8/24

(52) U.S. Cl. CPC H04W 4/02; H04W 8/24

(57) ABSTRACT

Autonomously-operated ground and/or water-based transport devices can include a transport device body and mobile connectivity emulator device affixed to the transport device body to track nearby mobile devices with connectivity capabilities to assist with search and/or rescue operations. An on-board or external storage device can store captured emulator data and an on-board or external data processing means can convert the stored emulator data into tracking-related information. An on-board or external wireless communications device can transmit the tracking-related information to one or more communications receivers to assist in search and/or rescue operations of persons in the wilderness and/or disaster areas.

### FIELD OF THE INVENTION

The present invention relates to the use of manually-operated, autonomously-operated, and/or remotely-operated transport devices with tracking tools to assist in search and/or rescue operations of persons in the wilderness and/or disaster areas by locating mobile devices with connectivity capabilities.

### BACKGROUND

Mobile devices with connectivity capabilities are almost certainly located near the user's person at all times. For instance, a cellular device is a type of mobile device with connectivity capabilities that constantly communicates with and through the nearest cellular tower or base station. When no cellular tower is available for the device to connect with, the device is unable to communicate with the outside world. An example of this is after a hurricane or other natural or industrial disaster that damages the communications infrastructure in the area. Another example is when someone wanders into the wilderness outside of the reach of any given cellular tower. However, even though a cellular device may not be connected to a cellular tower, it may have power which could possibly last for hours or even days. Additionally, a cellular tower's communications and management functionality includes identifying the various devices within the given area along with general location information.

This also applies for other mobile devices with connectivity capabilities such as a computer, tablet, smartwatch, fitness tracker, or other device that utilizes some sort of communications connectivity, such as Bluetooth or Wi-Fi. Similar to a cellular device and its connection with cellular towers, when no other communications connection, such as a Wi-Fi router/modem or pair-able Bluetooth device is available nearby for one of these other mobile devices with connectivity capabilities to connect to, the device is unable to communicate with the outside world. However, similar to a cellular device, though these other mobile devices with connectivity capabilities may not be connected to an applicable communications connection, it may have power which could possibly last for hours or even days. Additionally, the communications and management functionality of these communications connections, such as a Wi-Fi router/modem or pair-able Bluetooth device, includes identifying the various devices within a given range and can be configured to identify general location information.

Problem 1: Assume someone with any type of mobile device with connectivity capabilities is wandering in a large area without communications coverage, whether that be cellular, Bluetooth, Wi-Fi, etc. Moving a mobile connectivity emulator device (referred to as “MCE” from this point on) over an area without connectivity, such as in an aircraft flying or land-based transport device driving a search pattern, would cause a mobile device with connectivity capabilities and the MCE to link, and allow the MCE to determine a rough position or direction for that device and user's location. After several passes, it should be possible to estimate that device and user's position with suitable accuracy to effect a rescue.

Problem 2: After a natural or industrial disaster, such as a hurricane or industrial plant explosion, where the various communications infrastructures may be offline, some people may have chosen not to evacuate and now find themselves trapped and/or isolated. However, their mobile devices with connectivity capabilities may have hours or even days of battery life left. Traversing the damaged area with an MCE should enable the mapping of mobile devices with connectivity capabilities with locations such that emergency crews could be vectored to locate and contact the survivors.

Problem 3: If a ship at sea becomes disabled and unable to communicate, or if a passenger falls overboard or is otherwise lost at sea, a search will be started. Today, such a search is mostly visual, restricting it to daylight hours in good weather, limiting altitudes and speed of search. If an MCE was used to cover the search area, the search could be completed faster, cover dramatically more area per device time, could take place at night, and could result in a much higher probability of locating the ship and or device user.

If the MCE should contain sufficient functionality to support communications, it should be possible to communicate with the search targets. Furthermore, such a search as described above could also include a person or animal with a mobile device with connectivity capabilities, such as an ankle bracelet for house arrest, livestock ear tag, or embedded microchips.

An MCE could be used to search the area in a number of ways including use of a manually-operated transport device, autonomously-operated, and/or remotely-operated device. Without loss of generality, the following discussion centers upon transport device use, but anyone suitably skilled in the art can apply the principles herein in any of the above mentioned ways. Furthermore, without generality, the discussion centers upon the use of MCE technology though it should be clear to anyone suitably knowledgeable in the art that numerous other electromagnetic communications technologies (including radio and laser) could be substituted.

The use of manually-operated, autonomously-operated, and/or remotely-operated transport device, such as aerial, surface and/or water bound transport devices, are common-place in visual search and/or rescue operations for persons by emergency personnel in the wilderness and/or disaster areas. These include aircraft, land bound vehicles, such as a Jeep, and water bound vehicles, such as a boat or personal watercraft. In addition, personal autonomously-operated and/or remotely-operated transport devices currently exist and already assist in numerous areas, such as search and/or rescue, utility inspection, insurance, and other applications. The use of these devices to assist and improve the abilities of emergency personnel to track and locate persons is limitless. The application of adapting transport devices to utilize an MCE can make novel improvements in how emergency personnel facilitate search and/or rescue operations of persons in the wilderness and/or disaster areas.

### SUMMARY

Thus, to solve the problems noted above, a manually-operated, autonomously-operated, and/or remotely-operated transport device can include a transport device body and an MCE disposed on a transport device body to track nearby mobile devices with connectivity capabilities to assist with search and/or rescue operations. An on-board or external storage device can store captured emulator data and an on-board or external data processing means can convert the stored emulator data into tracking-related information. An on-board or external wireless communications device can transmit the tracking-related information to one or more communications receivers to assist in search and/or rescue of persons in the wilderness and/or disaster areas.

A further example of the present invention is a method of emergency personnel using a transport device with an MCE, which can include the steps of dispatching a transport device to one or more locations where a person is expected to be located, or to the location of an industrial or natural disaster. The method further includes retrieving the tracking-related information from the emulator device affixed to the transport device and using the tracking-related information to perform search and/or rescue operations. The search and/or rescue operations can include at least one of the mapping the user information and/or location of mobile devices with connectivity capabilities, the locating and extraction of users of mobile devices with connectivity capabilities, and determining the total count of mobile devices with connectivity capabilities and users in a given wilderness and/or disaster area. It is understood that these specific functions are not mutually exclusive and each share the common goal of facilitating effective search and/or rescue operations.

### BRIEF DESCRIPTION OF THE DRAWINGS

This invention is described with particularity in the appended claims. The above and further aspects of this invention may be better understood by referring to the following description in conjunction with the accompanying drawings, in which like numerals indicate like structural elements and features in various figures. The drawing figures depict one or more implementations in accord with the present teachings, by way of example only, not by way of limitation. In the figures, like reference numerals refer to the same or similar elements.

FIG. 1 illustrates a transport device setup with an MCE, an on-board storage means, an on-board data processing means, and an on-board wireless communications unit;

FIG. 2 illustrates an aerial transport device equipped with an MCE traversing a designated wilderness or disaster area to establish a connection with a mobile device with connectivity capabilities within the designated area.

### DETAILED DESCRIPTION

In the following detailed description, specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

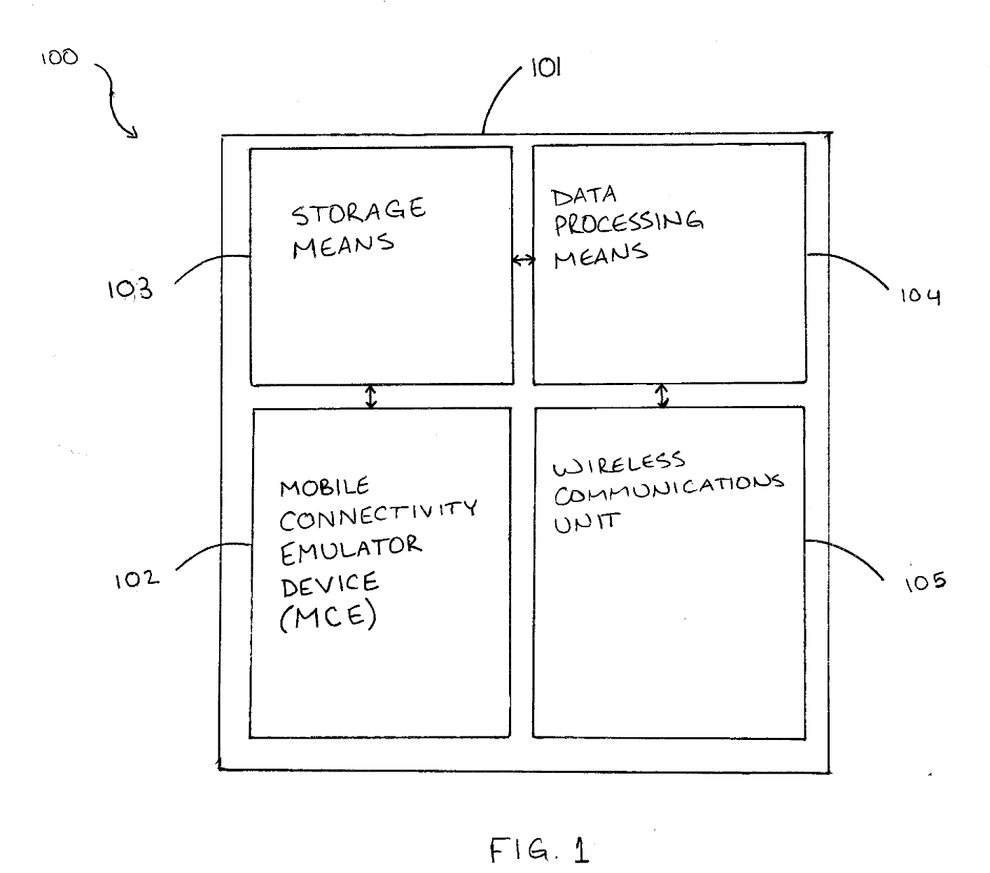

FIG. 1 illustrates a transport device 100 setup with a transport device body 101, an MCE 102, an on-board storage means 103, an on-board data processing means 104, and an on-board wireless communications unit 105.

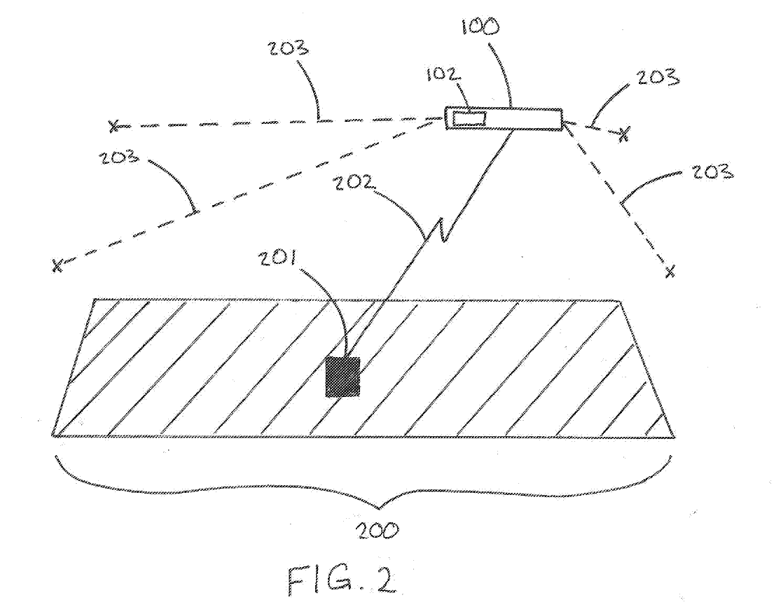

FIG. 2 illustrates an aerial transport device 100 equipped with an MCE 102 traversing a designated wilderness or disaster area 200 to establish a connection 202 with a mobile device with connectivity capabilities 201 within the designated area 200 by establishing a connection 202 at various geospatial locations 203 within the designated area 200. For search and/or rescue operations, data regarding the location of a mobile device with connectivity capabilities 201 and/or user in the designated area 200 is critical to the proper allocation of emergency response personnel to locate the mobile device with connectivity capabilities 201 and its user.

An MCE 102 is a device that forces mobile devices with connectivity capabilities 201 within a designated area 200 to connect to the MCE 102 and transmit data to the MCE 102. This type of MCE 102 can be used to identify and track a phone or other mobile device with connectivity capabilities 201, such as a computer, tablet, smartwatch, or fitness tracker, even while the device is not engaged in an active connection. This type of MCE 102 essentially acts as a portable communications tower that transmits signals, such as cellular, Wi-Fi, and Bluetooth, to have mobile devices with connectivity capabilities 201 within a designated area 200 or range connect to the MCE 102. Mobile devices with connectivity capabilities 201 are commonly programmed to constantly search for and connect to a connection point with the strongest signal in the area. When a mobile device with connectivity capabilities 201 and this type of MCE 102 connect, a compatible data processing means 104 determines the location of the device by analyzing the strength of the signal being transmitted to the device. This process can be repeated numerous times by a single transport device 100, or multiple transport devices at various geospatial locations 203 within a designated area 200 to connect to the mobile device with connectivity capabilities 201. Once signal strength is determined from these locations, the data processing means 104 analyzes the data and is able to establish a location of the device. Any type of transport device 100, such as aerial, ground, or water-based, affixed with an MCE 102 can be used singularly or in conjunction with other transport devices of the same or different type by converting a transport device 100 MCE data into tracking-related information to be analyzed in conjunction with the MCE data of all other transport devices used in the designated area 200. All transport devices used will transmit MCE data through the individual wireless communications units 105 in communication with the individual data processing means 104 to transmit the tracking-related information to one or more communications receivers to assist in search and/or rescue of persons in the wilderness and/or disaster areas

In general, a transport device 100 can be outfitted with any number of emulators to collect data, including cameras, thermal imaging, low-light imaging, photo receptors, radar, temperature probes, atmospheric probes, etc. This data can be processed on-board the transport device 100 with an on-board data processing means 104 or externally by manually transferring the stored MCE data by utilizing an on-board or removable memory storage means 103, such as a memory stick, or by wirelessly transmitting the MCE data through a wireless communications unit 105 to a computer system to be processed and developed into actionable information. The data processing means 104 can be any programmable central processing device (CPU) designed or programmed to process and convert stored MCE data into tracking-related information, such as an on-board data processing device or an external laptop computer. The wireless communications unit 105 can allow a transport device 100 to send raw or processed MCE or tracking-related data and receive control information in real-time and can be configured to communicate on any wireless communications network, including a radio frequency, Bluetooth, or Wi-Fi. Further, the wireless communications unit 105 can be configured to communicate with ground, water, air, and/or satellite based transceivers to provide unlimited range between a transport device 100 and the base either receiving the data and/or controlling a transport device 100.

An example of an aerial transport vehicle 100 is an unmanned aerial vehicle (UAV). A UAV is an aerial vehicle without a human pilot aboard and can be controlled either autonomously by onboard computers, by the remote control of a pilot on the ground or in another transport device 100, or by some combination of autonomous and remote control. A typical launch and recovery method of an autonomously-operated, aircraft is by the function of an automatic system or an external operator on the ground. UAVs are often preferred for missions that are not compatible or safe for manually-operated aerial aircraft. UAVs, due to the reduced size and complexity, also offer significant cost benefits over conventional manually-operated transport devices. Additionally, UAVs are most effective in situations that limits the access, safety and operability of ground-based or water-based transport devices, such as an industrial or natural disaster area, collapsed buildings, landlocked areas with limited surface or water ingress and egress access, etc. Further, other types of transport devices, discussed above, such as surface or water bound transport devices, can also be used. The use of ground-based transport devices is ideal for conditions that would limit the effectiveness, safety, or operability of an aerial or water-bound transport device, such as situations of high-winds, storms, or limited aerial or water access.

A transport device 100 can be used in numerous civilian activities, such as inspection, videography, etc. One benefit of a transport device 100 is that it can perform frequent and/or extended surveillance of a designated area inexpensively. Finally, the use of transport devices affixed with mobile connectivity emulators in conjunction with other commonly utilized transport device-adapted sensors, such as a GPS, photoreconnaissance, RADAR, thermal imaging, etc., has the ability to improve the effectiveness of search and/or rescue operations by using features of each sensor to optimize locating devices and or/persons.

Having an MCE 102 affixed to a transport device 100 can benefit search and/or rescue operations following a report of a person or persons missing in the wilderness, or after an industrial or natural disaster, to efficiently navigate a designated area 200 that is not navigable by other manually-operated transport devices or when resources or time do not allow for a timely application of manually-operated transport devices to determine the location of a mobile devices with connectivity capabilities 201 within a designated area 200 to dispatch emergency search and/or rescue personnel to the specified location of the device and user.

While the foregoing has described what is considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. An autonomously-operated ground and/or water-based transport device system to locate one or more mobile devices with connectivity capabilities, comprising:
a transport device body;
a mobile connectivity emulator device affixed to said transport device body and configured to capture identifying data of one or more mobile devices with connectivity capabilities of communicating with the mobile connectivity emulator device;
one or more storage devices for storing said identifying data;
one or more on-board or external data processing devices configured to translate said identifying data into tracking-related information; and
one or more wireless communications devices affixed to transport device body with capability of being connected with said data processing device capable of transmitting the tracking-related information to one or more communications receivers.

2. (canceled)

3. (canceled)

4. (canceled)

5. The system according to claim 1, wherein one or more said autonomously-operated ground and/or water-based transport device systems are used in a coordinated operation.

6. The system according to claim 1, wherein said storage device is a removable storage device that is capable of being connected to one or more data processing devices.

7. The system according to claim 1, wherein said storage device is configured to store identifying data of one or more mobile devices with connectivity capabilities with data indicative of device identification, location and time.

8. The system according to claim 1, wherein said storage device is configured to store tracking-related information of one or more mobile devices with connectivity capabilities translated by said data processing device with data indicative of device identification, location and time.

9. The system according to claim 1, wherein said data processing device is affixed to transport device body configured to receive identifying data from said storage device and capable of transmitting tracking-related information to said storage device, or to said communications receivers using said wireless communications devices.

10. The system according to claim 1, wherein said data processing device is an external data processing device configured to receive identifying data from said storage device and translate into tracking-related information.

11. The system according to claim 10, wherein said wireless communications device is in communication with one or more data processing devices affixed to a transport device body and capable of transmitting identifying data and/or tracking-related information to one or more communications receivers.

12. The system according to claim 1, wherein said wireless communications device is capable of being configured to transmit captured identifying data and/or tracking-related information from said storage device and/or data processing device automatically upon translation by said data processing device.

13. A method of utilizing one or more autonomously-operated ground and/or water-based transport device systems to locate one or more mobile devices with connectivity capabilities, comprising the steps of:
dispatching one or more autonomously-operated ground and/or water-based transport devices affixed with a mobile connectivity emulator device to one or more geospatial locations within one or more designated areas;
capturing identifying data of one or more mobile devices with connectivity capabilities communicating with the mobile connectivity emulator device;
storing said identifying data to one or more storage devices configured to store identifying data of one or more mobile devices with connectivity capabilities with data indicative of device identification, location and time;
translating said identifying data into tracking-related information using one or more on-board or external data processing device;
transferring said tracking-related information to one or more communications receivers using one or more wireless communications devices; and
using the tracking-related information to locate one or more mobile devices with connectivity capabilities.

14. A method according to claim 13, wherein said transport devices can be any combination of one or more autonomously-operated ground and/or water-based transport devices.

15. A method according to claim 13, wherein said storage device is a removable storage device that is capable of being connected to one or more data processing devices.

16. A method according to claim 13, wherein said storage device is configured to store identifying data of one or more mobile devices with connectivity capabilities with data indicative of device identification, location and time.

17. A method according to claim 13, wherein said storage device is configured to store tracking-related information of one or more mobile devices with connectivity capabilities translated by said data processing device with data indicative of device identification, location and time.

18. A method according to claim 13, wherein said data processing device is affixed to transport device body capable of transmitting tracking-related information to said storage device or to said external communications receivers using said wireless communications devices.

19. A method according to claim 13, wherein said data processing device is an external data processing device configured to receive identifying data from said storage device and translate into tracking-related information.

20. A method according to claim 13, wherein said wireless communications device is in communication with one or more data processing devices affixed to a transport device body and capable of transmitting identifying data and/or tracking-related information to one or more external communications receivers.

21. A method according to claim 13, wherein said wireless communications device is capable of being configured to transmit captured identifying data and/or tracking-related information from said storage device and/or data processing device automatically upon translation by said data processing device.

22. The system according to claim 11, wherein said mobile connectivity emulator device is capable of being configured to be powered by the transport device body and/or an uninterruptible power source.

23. The system according to claim 22, wherein said external data processing device is capable of being configured to receive identifying data from said storage device remotely.

24. The system according to claim 23, wherein said wireless communications device is capable of being configured to transmit captured identifying data and tracking-related information from said storage device and said data processing device automatically upon translation by said data processing device.
